(19) United States
(12) Patent Application Publication
(10) Pub. No.: US 2007/0121559 A1
(43) Pub. Date: May 31, 2007

(54) Routing switch for parameterized routing in mesh networks

(75) Inventors: Ariton Xhafa, Plano, TX (US); Shantanu Kangude, Dallas, TX (US); Anuj Batra, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/436,835

(22) Filed: May 18, 2006

Related U.S. Application Data
(60) Provisional application No. 60/682,719, filed on May 19, 2005.

(51) Int. Cl. H04Q 7/24

(52) U.S. Cl. 370/338; 370/408

(57) ABSTRACT

A wireless device for routing data in a mesh network is provided. The device includes a component operable to promote routing in the mesh network according programmable parameters. The wireless device includes a transmitter operable to promote communications with at least one other device in the mesh network.

### CROSS-REFERENCE TO RELATED APPLICATIONS

This application claims priority to U.S. Provisional Application No. 60/682,719, filed May 19, 2005, entitled “Routing Switch for Parameterized Routing in Mesh Networks”, Ariton Xhafa, et al. inventors, which is incorporated herein by reference for all purposes.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present disclosure is directed to wireless networks, and more particularly, but not by way of limitation, to a method and system for routing traffic through a mesh network.

### BACKGROUND OF THE INVENTION

The ability to access high speed and high performance data networks is becoming increasingly important to data clients. Wireless network access is needed in many areas where wired infrastructure is non-existent, outdated, or impractical. In some environments, fixed wireless broadband networks can perform this function. However, the effectiveness of fixed wireless broadband technology is limited due to a combination of technological constraints and high deployment costs. For example, each conventional Wireless Local Area Network (WLAN) technology access point must be connected directly to a wired backbone infrastructure.

To address the problem of access point tethering, mesh networks have been studied as an alternative. However, the effectiveness of wireless mesh networking is severely limited. In its most basic form, the mesh network is limited by its network capacity due to the requirement that nodes forward each others' packets. This forwarding of packets carries a corresponding increase in data overhead, making the mesh network inefficient. Finding ways to efficiently route traffic to minimize network overhead is, therefore, essential to extending both the efficiency and reliability of mesh networks.

### SUMMARY OF THE INVENTION

According to one embodiment, the present disclosure provides a wireless device for routing data in a mesh network. The device includes a component operable to promote routing in the mesh network according to programmable parameters. The wireless device includes a transmitter operable to promote communications with at least one other device in the mesh network.

Another embodiment of the present disclosure provides a component used by a wireless mesh point in a mesh network. The component includes logic operable to execute a programmable routing protocol. The programmable routing protocol is programmable with parameters such that in response to receiving one or more parameters, the routing protocol uses one or more of the parameters for routing.

Yet another embodiment of the present disclosure provides a method for routing traffic in a mesh network. This method includes associating one or more devices to the mesh network, and defining parameters related to routing protocols for the mesh network. The method includes receiving the parameters from one of the devices in the mesh network, and routing packets in the mesh network based on the parameters.

These and other features and advantages will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 illustrates an exemplary general-purpose mesh network suitable for implementing one embodiment of the present disclosure.

FIG. 2 illustrates a flow chart of one embodiment of the present disclosure for a MP node which communicates directly with a routing switch.

FIG. 3 illustrates an exemplary general-purpose mesh network suitable for implementing another embodiment of the present disclosure.

FIG. 4 illustrates a flow chart of one embodiment of the present disclosure for a MP node which does not communicate directly with a routing switch.

FIG. 5 illustrates an exemplary general-purpose mesh network suitable for implementing another embodiment of the present disclosure.

FIG. 6 illustrates a flow chart of one embodiment of the present disclosure where a MP node acts as both a routing switch and a mesh network node.

FIG. 7 illustrates a chart of connectivity choices between proactive and reactive routing algorithms.

FIG. 8 illustrates an exemplary general purpose computer system suitable for implementing the several embodiments of the disclosure.

### DETAILED DESCRIPTION OF THE PREFERRED EMBODIMENTS

It should be understood at the outset that although an exemplary implementation of one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein, but may be modified within the scope of the appended claims along with their full scope of equivalents.

The present disclosure according to one embodiment provides a routing switch capable of transmitting routing protocol information to mesh point (MP) nodes which have become associated to a network. When an MP node becomes associated with a network, a routing switch transmits an informational element in the form of a data packet to the MP node. This informational element contains the parameters for routing and the routing protocol to be used by the MP node while it is associated with the network. The present innovations may be used in any kind of network, but for illustrative purposely only are described in sections of this disclosure as part of a wireless mesh network. In some embodiments of the present disclosure, the routing switch determines the routing protocol and the routing parameters in which the MP node is to use. The routing protocol and routing parameters may be based upon a predetermined preference, while in other embodiments, the routing switch is capable of optimizing the network traffic by making a decision of which routing protocol and routing parameters will be used based upon network conditions and quality of service (QoS) parameters. The routing parameters and routing protocol that is selected by the routing switch may call for full topology discovery routing used in conjunction with link state routing, partial topology/minimum source tree advertisement, and one hop away discovery and advertisement.

In one embodiment, the routing switch is capable of sending an information element which includes, but is not limited to, information that can control the frequency in which MP nodes should obtain updates, the depth of network topology the MP nodes should store, and other network routing information. By controlling the frequency of updates and the depth of the network topology, the routing switch can balance network routing overhead and network routing efficiency. In this embodiment, the routing switch functions as a control layer that determines how each MP node operates, and the way that each MP node routes data.

According to another embodiment, the present disclosure provides a routing protocol which may be thought of as open or generic in that it may be programmed or modified with regard to specific routing protocol parameters. The parameters used by the protocol that may be modified, revised, or updated may include the information, such as the amount and type of topology information maintained or communicated between nodes, as well as the frequency of updates. In other embodiments, the present disclosure provides a component, such as but not limited to software, firmware, or circuitry, which may reside on a node, switch, access or mesh point, for example. The component is operable to execute the generic or open protocol and receive the routing parameters from, for example a router in the mesh network. Responsive to receiving the parameters, the component would then begin employing those routing parameters. It will be appreciated that although these parameter may be discussed in this disclosure as coordinated or transmitted by a router, any other electronic device in the network with sufficient capabilities might be used for these purposes and this disclosure is not limited to uses including only router devices.

I. Connectivity of WiFi Mobile Station Nodes to the Routing Switch

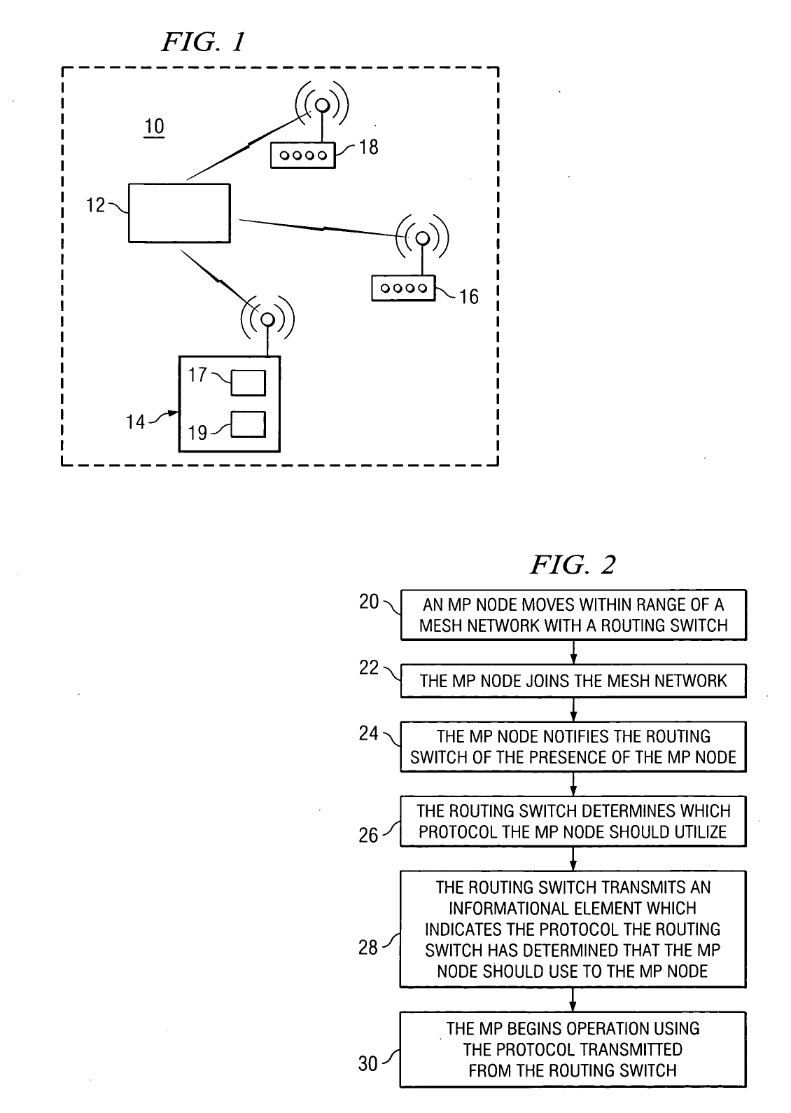

FIG. 1 illustrates one embodiment of a mesh network 10 suitable for use with the present disclosure. A routing switch 12 is capable of communication with a first MP node 14 and a second MP node 16. The first MP node 14 and second MP node 16 are associated with routing switch 12 through a wireless network. The present embodiment is not limited to use on a specific network and may be implemented on any wireless mesh network including, but not limited to, WiMAX, 802.11g, or any other wireless technology or topography. In one embodiment, a third MP node 18 either moves within range of routing switch 12 or is turned on while within range of routing switch 12 and attempts to become associated with mesh network 10. In one embodiment, the line between MP node 18 and routing switch 12 is intended to illustrate that the third MP node 18 is in the process of becoming associated with mesh network 10. In one embodiment of the present disclosure, when third MP node 18 has become associated with mesh network 10 and begins communication with routing switch 12, an informational element is sent from routing switch 12 to the third MP node 18 indicating the attributes of the routing protocol that the third MP 18 node should use. Routing switch 12 may also have all of the functionality of a MP node, or may be dedicated as only a stand alone routing switch. Routing switch 12 may also update the parameters of protocols used by the first MP node 14, second MP node 16, or third MP node 18 while those nodes are associated with mesh network 10.

MP Node 14 includes a transceiver 17 capable of wirelessly sending and receiving data packet and a component 19. Component 19 includes logic which may include or be implemented using one or more processors, circuitry, software, firmware, or systems capable of processing data, instructions, and rules including routing and other protocols. Although only node 14 is shown having the transceiver 17 and component 19, each of the other systems, including MP nodes 16 and 18 and routing switch 12 may have the transceiver and component 19 as well.

FIG. 2 is a flowchart illustrating example embodiments consistent with the third MP node 18 joining mesh network 10 using the routing switch 12 as shown in FIG. 1. In this flowchart, the MP node moves within range of the mesh network (Block 20). Once the MP node is within range of the network, the MP node becomes associated with and joins the mesh network (Block 22). Either after joining the mesh network, or during the process of joining the mesh network, the MP node notifies the routing switch of the presence of the MP node (Block 24). This notification can take the form of a DHCP request, a broadcast made from the MP node, or any other network transmission initiated by either the MP node or the routing switch which will alert the routing switch to the presence of the MP node. The routing switch will then determine which protocol the MP node should use (Block 26). The routing switch transmits an informational element to the MP node that indicates the protocol the routing switch has determined the MP node should use. The transmission of the informational element can be preformed in any way known to one skilled in the art, including, but not limited to TCP/IP packets containing protocol routing information. The MP node, along with the other nodes in the mesh network, operates using the protocol transmitted from the routing switch (Block 30).

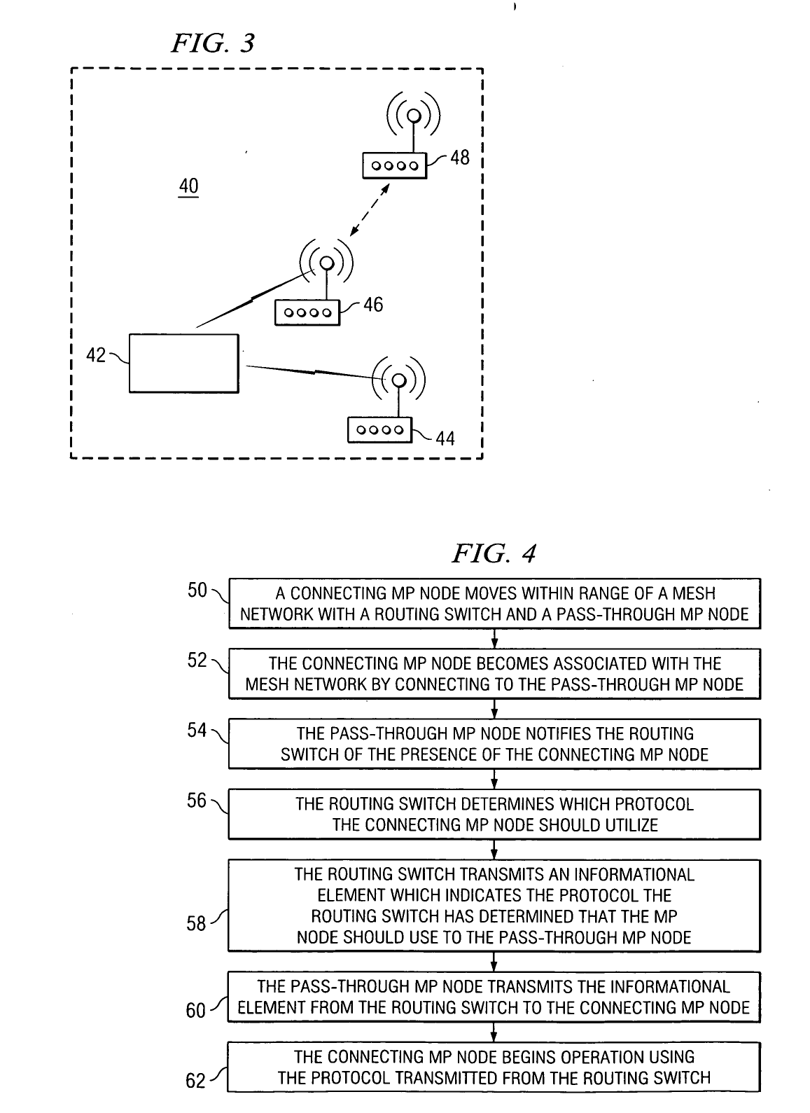

FIG. 3 is an example of the embodiment where the MP node is connected to the routing switch through an intermediary mesh node. In the example embodiment shown in FIG. 3, wireless network 40 contains a first MP node 44, a second MP node 46, and a third MP node 48. In this embodiment, the first MP node 44 and second MP node 46 are associated with mesh network 40, and connected to routing switch 42. The third MP node 48 is in the process of becoming associated with mesh network 40, but cannot communicate directly with routing switch 42. The third MP node 48 therefore becomes associated with mesh network 40 through communications with the second MP node 46. In this embodiment, the second MP node 46 acts as a pass-through for data between the third MP node 48 and routing switch 42. Routing switch 42 may also have all of the functionality of a MP node, or may be dedicated as only a stand alone routing switch.

FIG. 4 is a flowchart illustrating one example embodiment where a wireless MP node is used as a pass-through for data between another MP node and a routing switch. In this flowchart, the third MP node 48, referred to as the connecting MP node, the second MP node 46, referred to as the pass-through MP node, and the routing switch 42 are discussed. In this embodiment, a connecting MP node moves within range, or is activated within the range, of a mesh network with a routing switch and a pass-through MP node (Block 50). The connecting MP node, in this example embodiment, is within range of the pass-through MP node, but not within the range of the routing switch 12. A connecting MP node moves within range of a mesh network with a routing switch and a pass-through MP node. The connecting MP node becomes associated with the mesh network by connecting to the pass-through MP node (Block 52). The pass-through MP node notifies the routing switch of the presence of the connecting MP node (Block 54). The routing switch determines which protocol the connecting MP node should use (Block 56). The routing switch transmits an informational element which indicates the protocol the routing switch has determined that the MP node should use to the pass-through MP node (Block 58). The pass-through MP node transmits the informational element from the routing switch to the connecting MP node (Block 60). The connecting MP node begins operation using the protocol transmitted from the routing switch (Block 62).

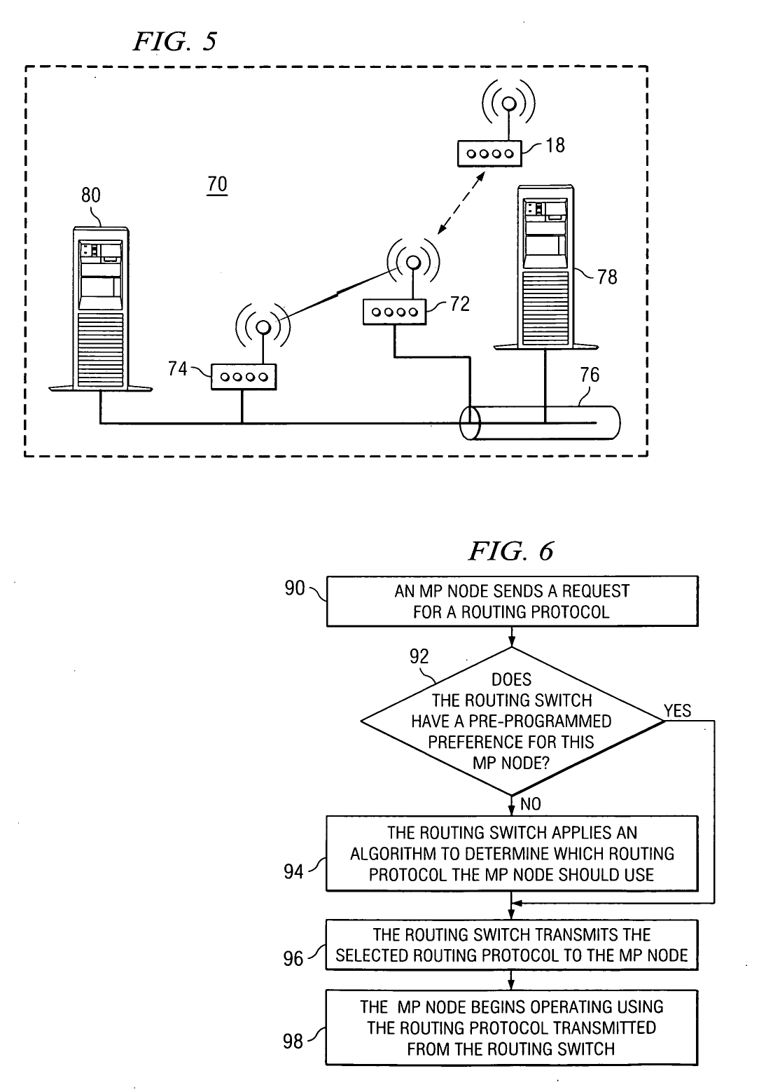

FIG. 5 is an example of another embodiment of the present system where there is an additional wired Ethernet connection 76 to wireless nodes 72, 74, and 18. In this example embodiment, the wireless routing switch may be connected to a first wired server 78 or a second wired server 80. The first wired server 78 and second wired server 80 may act as the routing switch, as well as allow for communication between the first MP node 72 and the second MP node 74. The embodiment illustrated by FIG. 5 shows that direct wired communication may co-exist with the wireless communication illustrated by the previous embodiments.

II. Determination of the Routing Protocol

The determination of the proper routing protocol to be used by a routing switch can be made on the basis of either a routing controlled algorithm or a programmed preference within the routing switch. There are several different types of protocols that are suitable for use by the routing switch. The routing protocol parameters that are selected for the routing protocol by the routing switch may call for full topology discovery routing used in conjunction with link state routing, partial topology/minimum source tree advertisement, and one hop away discovery and advertisement.

The routing protocol and the routing parameters that are selected are, in some embodiments, dependant upon the environment in which the network is deployed. For instance, in an emergency management center, such as a 911 call center, there may be a limited need for high volumes of traffic, while there is a need for highly efficient routing. In this environment, the full topology discovery may, in some embodiments, be preferred.

In other embodiments found in alternative deployment scenarios, such as a large business environment with many MP nodes, full topology discovery may be impractical. In this environment, there may be a need for a partial topology/minimum source tree advertisement, and one hop away discovery and advertisement. In this embodiment, the administrator will make a decision as to the most efficient routing protocol and parameters based upon network conditions.

For purposes of illustration and description, wireless routing protocols may be divided into two broad categories: table-driven protocols and demand-driven protocols. Table-driven protocols attempt to maintain up-to-date routing information for every node in the network. Each node maintains a routing table which is updated based on topology changes in the immediate neighborhood and routing table updates received from other nodes. Any updates to the routing table are propagated to other nodes in the network.

Demand-driven routing protocols, sometimes referred to as source-driven protocols, will initiate a route discovery process only when a source node requires a route to a destination. The route discovery process is terminated once a route is found or all possible routes have been examined. Once a route is established, it is maintained by a route maintenance procedure until a route to the destination is no longer desired or the destination node becomes inaccessible.

Table-driven and demand-driven protocols may also be referred to as proactive and reactive protocols, respectively. Table-driven protocols may be thought of as proactive since they provide low latency in route establishment at the expense of high routing overhead in terms of signaling to maintain up-to-date routing information for every node in the network. Conversely, demand-driven protocols may be thought of as reactive as they have less overhead since routes are established only as needed, but the route establishment latency is high.

The routing switch, in one embodiment, uses a combination of the two routing protocols to balance the needs of the network for routing information with the overhead that is required to generate this routing information. Since the routing switch can dictate the routing protocol to be used by the nodes within the network, it can select the protocol which will be best suited for the demands of the network.

FIG. 6 is a flowchart of one embodiment of the present disclosure, where the routing switch determines which routing protocol to send to an MP node. When a request for a routing protocol is made by an MP node (Block 90), the routing switch determines if there is a pre-programmed preference for the MP node (Block 92). This pre-programmed preference may be any set value either for the particular MP node which is requesting the routing protocol for the network, or be a manually defined routing protocol which as been programmed by an end user. If there is such a preference for the particular MP node, the routing switch will transmit the routing protocol to the MP node (Block 96), and the MP node will begin operating using the routing protocol transmitted from the routing switch (Block 98).

If there is no pre-programmed preference for the MP node which is becoming associated with the network, the routing switch will apply an algorithm to determine which routing protocol the MP should use (Block 94). This algorithm may be based on any number of factors, including, but not limited to, Quality of Service (QoS) parameters, predefined bandwidth constraints, or the order in which the MP node is associating with the network. A protocol which uses QoS parameters may be useful in some embodiments of the present disclosure, and information regarding such protocol may be found U.S. patent application Ser. No. ______ entitled “Quality of Service Aware Robust Link State Routing For Mesh Network, inventors Xhafa et al., Docket No. (TI-60530)(1962-35200), filed on May 11, 2006, which is incorporated herein in its entirety for all purposes. Quality of service parameters may also include, but are not limited to, signal strength, battery status, and signal to noise ratio, jitter, delay. The routing switch will transmit the selected routing protocol to the MP node (Block 96), and the MP node will begin operating using the routing protocol transmitted from the routing switch (Block 98). One embodiment of the present disclosure allows the routing switch to update the parameters of the routing protocol used by the network device, should the routing switch determine that a change was necessary. Such a change might be triggered by network conditions, or the addition or subtraction of MP nodes.

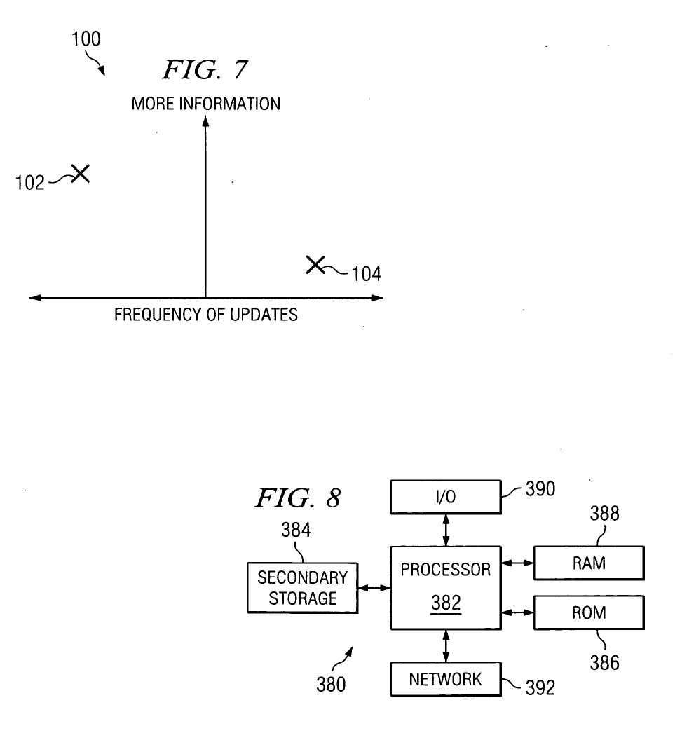

A graphical chart of the options for the choice in routing protocols and the application of the routing protocols is shown in FIG. 7. In this chart, the X-Axis represents frequency of updates that a routing switch makes, and the Y-Axis represents the amount of data stored by each routing switch. The low frequency updates indicates a more reactive protocol, where as the high frequency indicate a more proactive protocol. The amount of information stored generally, but not exclusively, refers to the distance in network hops between points, and the more information, means that there is more information about nodes between parts. The first point 102 shows a routing protocol where there is a significant amount of data that is updated infrequently. The second point 104 shows a routing protocol where there is less data stored, but that data is updated frequently. The algorithm to be used and transmitted from the routing switch can therefore be determined in any number of ways depending on network preferences. Therefore there are virtually an unlimited number of network parameters that can be applied to a network protocols that can be used consistent with the present disclosure.

The system described of a routing switch may be implemented on any general-purpose computer with sufficient processing power, memory resources, and network throughput capability to handle the necessary workload placed upon it. FIG. 8 illustrates a typical, general-purpose computer system suitable for implementing one or more embodiments disclosed herein, including operating as a data node. The computer system 380 includes a processor 382 (which may be referred to as a central processor unit or CPU) that is in communication with memory devices including secondary storage 384, read only memory (ROM) 386, random access memory (RAM) 388, input/output (I/O) 390 devices, and network connectivity devices 392. The processor may be implemented as one or more CPU chips.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage. The RAM 388 is used to store volatile data and perhaps to store instructions. Access to both ROM 386 and RAM 388 is typically faster than to secondary storage 384.

I/O 390 devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices 392 may take the form of modems, modem banks, ethernet cards, universal serial bus (USB) interface cards, serial interfaces, token ring cards, fiber distributed data interface (FDDI) cards, wireless local area network (WLAN) cards, ultra-wideband (UWB) cards, radio transceiver cards such as code division multiple access (CDMA) and/or global system for mobile communications (GSM) radio transceiver cards, and other well-known network devices. These network connectivity 392 devices may enable the processor 382 to communicate with an Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave

Such information, which may include data or instructions to be executed using processor 382 for example, may be received from and outputted to the network, for example, in the form of a computer data baseband signal or signal embodied in a carrier wave. The baseband signal or signal embodied in the carrier wave generated by the network connectivity 392 devices may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 382 executes instructions, codes, computer programs, scripts which it accesses from hard disk, floppy disk, optical disk (these various disk based systems may all be considered secondary storage 384), ROM 386, RAM 388, or the network connectivity devices 392.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A component used by a wireless mesh point in a mesh network, comprising:
logic operable to execute a programmable routing protocol, the routing protocol operably programmable with parameters such that in response to receiving one or more parameters, the routing protocol uses the parameter for routing.

2. The component of claim 1, wherein the parameters program an amount of information used by the routing protocol.

3. The component of claim 1, wherein the parameters program a frequency of updates by mesh points of at least some routing information.

4. The component of claim 1, wherein the parameters relate to a type of information programmable for use by the protocol.

5. The component of claim 4, wherein the type of information includes full topology discovery routing used in conjunction with link state routing, partial topology/minimum source tree advertisement, and one hop away discovery and advertisement.

6. The component of claim 4, wherein the type of information includes a depth of network topology that one or more of the access points should store.

7. The component of claim 1 wherein the logic is implemented using one item selected from the group consisting of circuitry, software, and firmware.

8. A wireless device for routing data in a mesh network, comprising:
a component operable to promote routing in the mesh network according programmable parameters; and
a transmitter operable to promote communications with at least one other device in the mesh network.

9. The wireless device of claim 8, wherein the component is further operable to operate according to a first set of parameters at a first time period and a second set of parameters at a second time period.

10. The wireless device of claim 8, wherein the programmable parameters are received during one of initialization or during an association time with the mesh network.

11. The wireless device of claim 8, wherein at least one of the programmable parameters include an amount of information about the mesh network.

12. The wireless device of claim 8, wherein the programmable parameters include a frequency of updates between at least the wireless device and another device in the mesh network.

13. The wireless device of claim 8, wherein the programmable parameters include a depth of network topology that the wireless device maintains.

14. The wireless device of claim 8, wherein the component is operable to receive one or more programmable parameters via the transmitter and route related to the programmable parameter.

15. The wireless device of claim 8, wherein wireless device is a router and wherein the router transmits via the transmitter to propagate to other devices in the mesh network programmable parameters for routing.

16. The wireless device of claim 8, wherein the component is further defined as a component selected from the group consisting of circuitry, software, and firmware.

17. A method for routing traffic in a mesh network, comprising:
associating one or more devices to a mesh network;
defining parameters related to routing protocols for the mesh network;
receiving the parameters from one of the devices in the mesh network; and
routing in the mesh network based on the parameters.

18. The method of claim 17, wherein the parameters are chosen based upon a network application and QOS parameters of the mesh network.

19. The method of claim 18, wherein the parameters in include one of a full topology discovery and link state routing protocol, a partial topology discovery protocol, and a one hop away discovery protocol.

20. The method of claim 17, further comprising:
changing one or more of the parameters;
receiving one or more of the changed parameters; and
routing according to the changed parameter.
